(19) United States
(12) Patent Application Publication
(10) Pub. No.: US 2005/0097616 A1
(43) Pub. Date: May 5, 2005

(54) Display system, broadcast signal processing unit, and display apparatus

(75) Inventor: Takehiko Numata, Hidaka-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/942,806

(22) Filed: Sep. 17, 2004

(30) Foreign Application Priority Data
Oct. 31, 2003 (JP) 2003-373628

(51) Int. Cl. H04N 7/173; H04N 5/44; H04N 5/50

(52) U.S. Cl. 725/100; 725/131; 348/725; 348/731

(57) ABSTRACT

A display system includes broadcast signal processing unit corresponds to plurality of video broadcasting systems differing from each other; and information processing terminal the broadcast signal processing unit is installed in, broadcast signal processing unit including demodulator receives broadcast signal including video signal and demodulates video signal, data generator generates digital video data on the basis of the demodulated video signal, transmitter transmits video data to information processing terminal, and notifying section informs information processing terminal of identification information about video broadcasting system broadcast signal processing unit corresponds to, and information processing terminal including receiver receives video data transmitted from transmitter, determining section determines video broadcasting system broadcast signal processing unit corresponds to, from the identification information notified by notifying section, video generator processes received video data according to determined video broadcasting system and generates display video, and display section displays display video visually.

### CROSS-REFERENCE TO RELATED APPLICATIONS

This application is based upon and claims the benefit of priority from the prior Japanese Patent Application No. 2003-373628, filed Oct. 31, 2003, the entire contents of which are incorporated herein by reference.

### BACKGROUND OF THE INVENTION

1. Field of the Invention

This invention relates to a display system, a broadcast signal processing unit, and a display apparatus.

2. Description of the Related Art

In recent years, notebook personal computers (hereinafter, referred to as notebook PCs) which include a television tuner have become available. Connecting this type of notebook PC to an antenna enables users to enjoy a television broadcast service easily.

With the recent technical innovation, notebook PCs have been made still smaller and lighter. As notebook PCs become smaller and lighter, they-are used more frequently not only in homes and offices but also in places where people go. Today, it is not uncommon for tourists overseas to bring notebook PCs with them to their destinations. Businesspeople making a lot of overseas business trips particularly have more chances to use their own notebook PCs in various countries. Against this backdrop, there has been a need for the user to be able to watch television broadcasts in various countries on a single notebook PC.

However, it is almost safe to say that television broadcasting systems differ from country to country. Installing the functions corresponding to all of the systems in a notebook PC involves the expansion of the receiving circuit and an increase in the burden or processing software. For example, since the synchronizing frequency of the video signal differs in different broadcasting systems, it is necessary to provided a synchronizing signal separator for each system. However, this approach results in an increased waste of hardware and therefore is at a disadvantage in power consumption, weight, and cost. Therefore, there have been demands for the proposal of a method of dealing with different broadcasting systems without ruining the many advantages, including portability, compactness, and lightness, of notebook PCs.

The related techniques have been disclosed in Jpn. Pat. Appln. KOKAI Publication No. H7-75034 (reference 1). This reference has disclosed a multi-signal receiving apparatus capable of receiving various broadcasts and displaying images on a plurality of channels on the same screen. However, the apparatus disclosed in the reference lies in the scope of an existing display apparatus which provides a separate signal processor for each broadcasting system. Therefore, the apparatus is unsuitable for use with portable devices.

### BRIEF SUMMARY OF THE INVENTION

According to an aspect of the present invention, there is provided a display system comprising a broadcast signal processing unit which corresponds to at least one of a plurality of video broadcasting systems differing from each other; and an information processing terminal in which the broadcast signal processing unit is installed, the broadcast signal processing unit including a demodulator which receives a broadcast signal including a video signal and demodulates the video signal, a data generator which generates digital video data on the basis of the demodulated video signal, a transmitter which transmits the video data to the information processing terminal, and a notifying section which informs the information processing terminal of identification information about a video broadcasting system to which the broadcast signal processing unit corresponds, and the information processing terminal including a receiver which receives video data transmitted from the transmitter, a determining section which determines a video broadcasting system to which the broadcast signal processing unit corresponds, from the identification information notified by the notifying section, a video generator which processes the received video data according to the determined video broadcasting system and generates display video, and a display section which displays the display video visually.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing an embodiment of a display system according to the present invention.

FIG. 2 is a perspective view schematically showing the display system of FIG. 1.

FIG. 3 shows the notebook PC 106 in which the tuner card 100 is installed, when viewed from the front of the slot.

FIG. 4 is a functional block diagram showing a first embodiment of a display system of FIG. 1 according to the present invention.

FIG. 5 is a flowchart for the processing procedure at the start-up of the display system of FIG. 4.

FIG. 6 is a functional block diagram showing the configuration of an existing multi-signal receiving apparatus for comparison's sake.

FIG. 7 is a functional block diagram of a second embodiment of the display system of FIG. 1.

FIG. 8 schematically shows another embodiment of the display system according to the present invention.

FIG. 9 schematically shows still another embodiment of the display system according to the present invention.

### DETAILED DESCRIPTION OF THE INVENTION

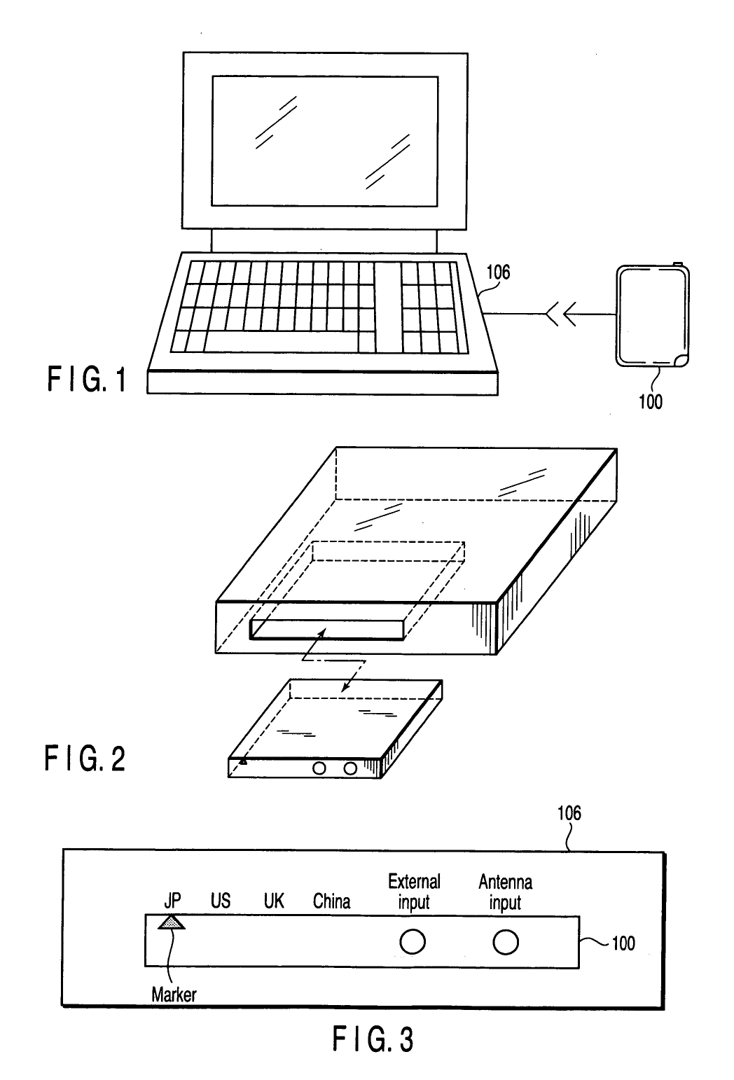

FIG. 1 is a schematic diagram showing an embodiment of a display system according to the present invention. The system of FIG. 1 comprises a notebook PC 106 acting as an information processing terminal and a tuner card 100 acting as a broadcast signal processing unit. The tuner card 100 is installed in the notebook PC 106.

FIG. 2 is a perspective view schematically showing the display system of FIG. 1. In the notebook PC 106, a dedicated slot 300 is made so as to fit the shape of the tuner card 100. The tuner card 100 is installed detachably in the notebook PC 106 via the slot 300.

FIG. 3 shows the notebook PC 106 in which the tuner card 100 is installed, when viewed from the front of the slot. On a panel of the notebook PC 106 in which the slot 300 is formed, the names of countries differing in broadcasting system are drawn in symbols. For example, JP means Japan, US means the United States, UK means the United Kingdom, and China means China. Drawing the names of the terminals in the places corresponding to the external input terminals and antenna input terminal of the tuner card 100 enables the individual terminals to be distinguished, which is convenient. In the description below, “broadcasting system” is a wide conceptual term including not only the difference between systems (e.g., NTSC and PAL) but also the difference between channel selection frequencies and the difference between signal formats.

On the tuner card 100, a triangular marker is drawn. The position where the marker is drawn on the tuner card 100 is caused to correspond to the broadcasting system that the tuner card 100 can deal with. In FIG. 3, the marker is drawn at the position shown by JP, which enables the user to know at a glance that the tuner card 100 corresponds to a broadcasting system in Japan. Drawing characters on the side of the notebook PC 106 makes characters easier to see and prevents the size of the tuner card 100 from being limited.

(First Embodiment)

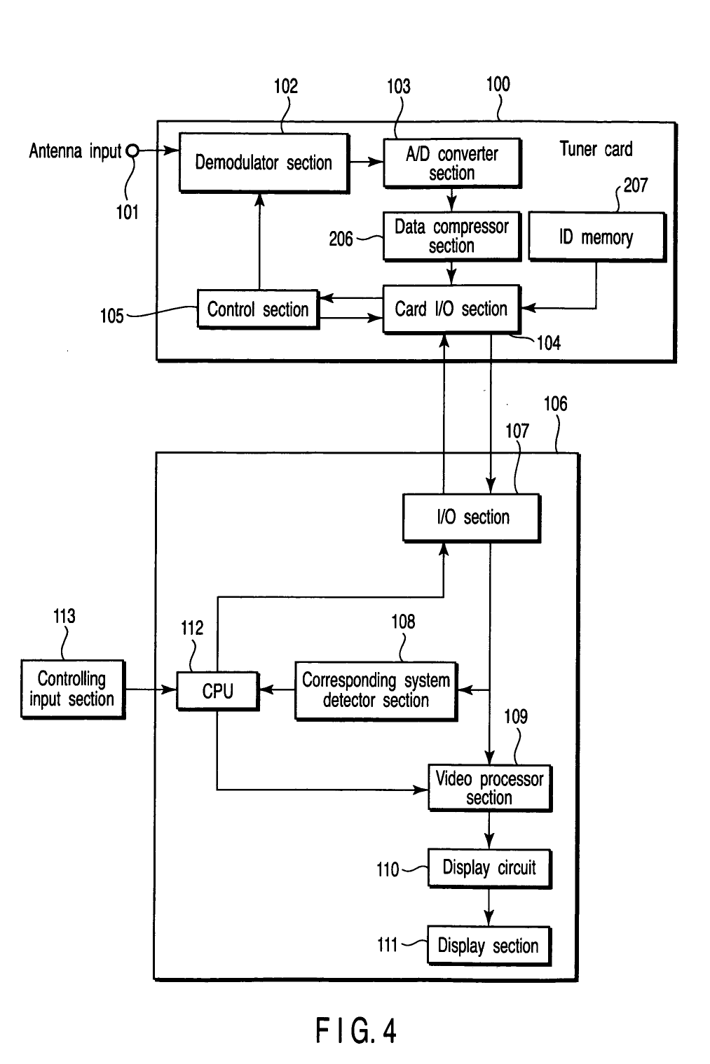

FIG. 4 is a functional block diagram showing a first embodiment of a display system of FIG. 1 according to the present invention. The tuner card 100 shown in FIG. 4 comprises a demodulator section 102, an analog-to-digital (A/D) converter section 103, a data compressor section 206, an ID memory 207, a card I/O section 104, and a control section 105. The notebook PC 106 comprises an I/O section 107, a corresponding system detector section 108, a central processing Unit (CPU) 112, a controlling input section 113, a video processor section 109, a display circuit 110, and a display section 111.

In FIG. 4, a broadcast signal is input via an antenna input terminal 101 to the tuner card 100. The broadcast signal is received and demodulated by the demodulator section 102, which demodulates an analog video signal superimposed on the broadcast signal. The video signal is converted into digital video data by the A/D converter section 103. The video data is compressed by the data compressor section 206 into such a form as MPEG 2 (Moving Picture Experts Group 2). The resulting compressed data is input to the card I/O section 104.

An ID memory 207 is realized in the form of a nonvolatile memory, such as an electrically erasable programmable read-only memory (EEPROM). The ID memory 207 stores identification information about the broadcasting system that the tuner card 100 can deal with. For example, use of 4-bit identification information enables 16 types of broadcasting systems to be identified. The card I/O section 104 reads identification information from the ID memory 207 and adds it to the compressed data.

The processing of each section in the tuner card 100 is supervised by the control section 105. For example, the control section 105 manages the data input/output processing at the card I/O section 104. In addition, the control section 105 also controls the channel selecting process and demodulating operation at the demodulator section 102.

The identification-information-added compressed data is transmitted from the card I/O section 104 to the I/O section 107 of the notebook PC 106 at a specific bit rate and a specific amplitude level with specific synchronization timing. The corresponding system detector section 108 of the notebook PC 106 extracts the identification information from the compressed data received from the I/O section 107 and determines a broadcasting system to which the tuner card 100 corresponds. The result of determining the broadcasting system is notified to the CPU 112 and is stored in an internal memory of the CPU 112.

The compressed data received by the I/O section 107 is also supplied to the video processor section 109. The CPU 112 informs the video processor section 109 of various parameters, including the signal format of the broadcasting system to which the tuner card 100 corresponds, the number of scanning lines, and the synchronizing signal timing. According to the individual parameters, the video processor section 109 adjusts the screen size of the compressed data, the display position, and the like, thereby producing display video. The display video is supplied to the display circuit 110. The display circuit 110 converts the display video into a form complying with the input form of the display section 111. The converted video is supplied to the display section 111, which displays the video.

The controlling input section 113 of the notebook PC 106 has an input device, such as a keyboard or a mouse (not shown). The user's reception channel selecting operation is notified as an event to the notebook PC 106 via the controlling input section 113. When an event corresponding to channel selection has occurred, the reception channel information specified in the event is notified to the CPU 112. In response to the notice, the CPU 112 carries out an interrupt process, thereby creating a channel specify code in the broadcasting system to which the tuner card 100 corresponds. The code is notified to the I/O section 107.

The I/O section 107 transmits the channel specify code to the card I/O section 104. The card I/O section 104 informs the control section 105 of the channel specify code. According to the informed channel specify code, the control section 105 controls the channel select frequency at the demodulator section 102. According to the above processing procedure, the channel select/demodulation operation can be controlled by the notebook PC 106.

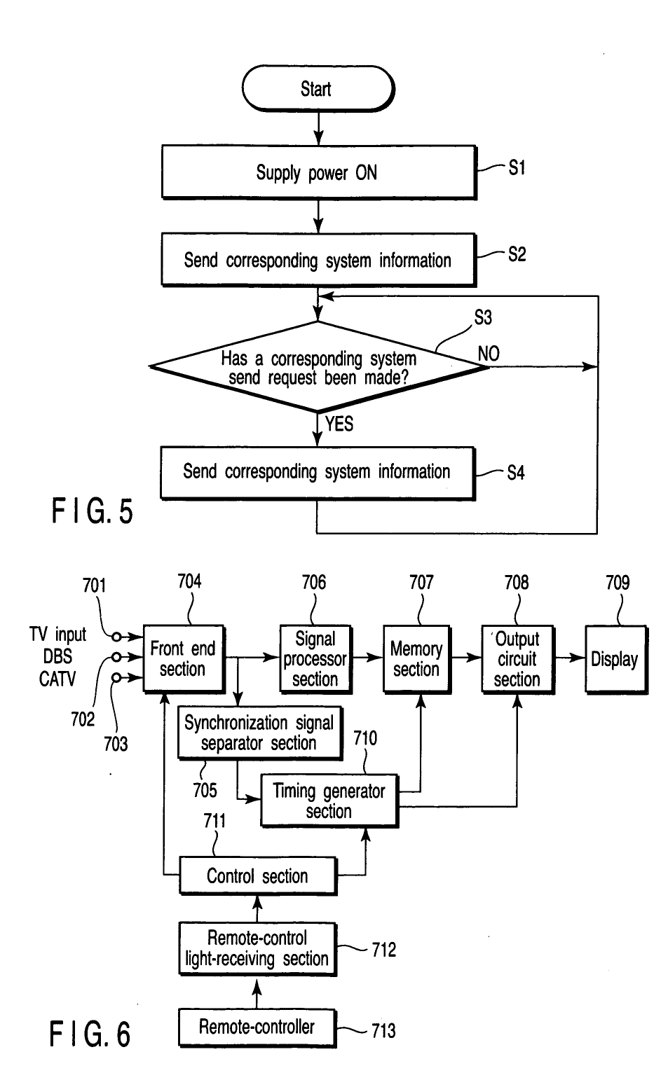

FIG. 5 is a flowchart for the processing procedure at the start-up of the display system of FIG. 4. In FIG. 5, when the tuner card 100 is connected to the notebook PC 106 or when power is supplied to the tuner card 100 (step S1), the control section 105 of the tuner card 100 reads identification information from the ID memory immediately. The control section 105 sends the read-out identification information via the card I/O section 104 to the notebook PC 106 (step S2). Receiving the identification information, the notebook PC 106 displays the name of the broadcasting system, the name of the country, and the like to which the tuner card 100 corresponds, in the form of characters or icons on the display section 111. The symbol representing the broadcasting system is shown as an on-screen display (OSD) on the display section 111. This enables the user to know the broadcasting system of what country the currently installed card corresponds to.

Then, the control section 105 waits for an identification information send request to arrive from the notebook PC 106 (step S3). When the send request has arrived, the control section 105 sends broadcasting system identification information about the broadcasting system to the notebook PC 106 immediately (step S4). As described above, the notebook PC 106 100 requests the tuner card 100 to send identification information. The tuner card 100 then responds to the request, thereby exchanging the identification information. This prevents interrupt events from occurring too often, which prevents the computing procedure in the CPU 112 of the notebook PC 106 from becoming complicated. Even when the tuner card 100 is replaced with one other card, it is possible to display immediately a broadcasting system that the one other card can deal with.

FIG. 6 is a functional block diagram showing the configuration of an existing multi-signal receiving apparatus for comparison's sake. The apparatus comprises a input terminal 701 to which a TV broadcast signal is input, an input terminal 702 to which a direct broadcast satellite (DBS) signal is input, and an input terminal 703 to which a CATV signal is input. Each of the signals connected to the input terminals 701 to 703 is also input to a front end section 704.

When the user operates a remote controller 713 to specify a reception broadcast channel, a remote-control light-receiving section 712 outputs a channel specify signal to the control section 711. The control section 711 controls the front end section 704 so as to select the specified channel. Under the control of the control section 711, the front end section 704 selects the signal from any one of the input terminals 701 to 703 and demodulates the selected signal. The demodulated signal is input to a signal processor section 706 and a synchronizing signal separator section 705.

The signal processor section 706 digitizes the demodulated signal, thereby producing video data. The synchronizing signal separator section 705 separates a synchronizing signal from the demodulated signal. The synchronizing signal is supplied to a timing generator section 710. The timing generator section 710 outputs a timing signal synchronizing with the synchronizing signal. A memory section 707 stores video data with write timing according to the timing signal. An output circuit section 708 reads video data from the memory section 707 with read timing according to the timing signal. The read-out video data is displayed on a display 709.

In the configuration of FIG. 6, each of the TV signal receiving and demodulating process, the DBS signal receiving and demodulating process, and the CATV signal receiving and demodulating process is carried out at the same front end section 704. For this reason, the circuit configuration of the front end section 704 is liable to be complicated and large in size. Moreover, since the apparatus takes in the analog demodulated signal from the front end section 704, noise in the apparatus can have an adverse effect on the demodulated signal. Furthermore, to cope with synchronizing frequencies differing from one broadcasting system to another, it is necessary to provide a dedicated synchronizing signal separator for each broadcasting system.

In contrast, in the first embodiment, the tuner card 100, which is provided with the demodulator section 102, receives and demodulates a broadcast signal. Identification information about the broadcasting system to which the tuner card 100 corresponds is stored in the ID memory 207 of the tuner card 100. Then, when the tuner card 100 is installed in the notebook PC 106, the identification information is read from the ID memory 207 and is notified to the notebook PC 106, which causes the notebook PC 106 to recognize the broadcasting system to which the tuner card 100 corresponds.

As a result, it is possible to separate the video display function from the broadcast signal receiving and demodulating function. That is, the tuner card 100 is replaced according to the broadcasting system to be received, which enables the single notebook PC 106 to deal with a different broadcasting system.

In the first embodiment, the number of broadcasting systems each tuner card 100 can deal with is limited to only one. For a desire to cope with a plurality of broadcasting systems, a tuner card 100 is provided separately for each system and is replaced with a suitable one. By doing this, the hardware configuration of the tuner card 100 can be reduced to a necessary minimum.

In the first embodiment, the slot 300 whose shape is caused to fit the shape of the tuner card 100 is made in the notebook PC 106. The tuner card 100 is installed in the notebook PC 106 via the slot 300. This realizes the advantage of determining the shape of the tuner card 100 freely.

Furthermore, in the first embodiment, a video signal is A/D converted into digital video data at the tuner card 100, which then transmits the data in a digital format to the notebook PC 106. This suppresses the effect of noise generated in the notebook PC 106 on the video signal, which enables high-quality video to be displayed. Using a metal case as the housing of the tuner card 100 produces a much greater noise reduction effect.

In the first embodiment, the synchronizing signal attendant on the video signal is reproduced at the tuner card 100. Then, the synchronizing signal can be multiplexed with the video data or transmitted from the tuner card 100 to the notebook PC 106 by an independent transmission system. As a result, a synchronizing signal separator becomes unnecessary in the notebook PC 106, which helps make the notebook PC 106 simpler and lighter.

In addition, the first embodiment has the following merit. For example, even in Japan and the United States where the NTSC system is used, the channel select frequency for the same channel number differs between the two countries. As in the first embodiment, the tuner card 100 informs the notebook PC 106 of the corresponding broadcasting system, which enables such a situation to be coped with.

Moreover, in the first embodiment, the broadcasting system that the installed tuner card 100 can deal with is displayed clearly. Therefore, the user can know the state of his or her system at a glance. This enables the user to determine whether to replace the tuner card 100, immediately after he or she comes back home or the day before departure. If some failure occurs after the user come back home from a country where a different broadcasting system was being used, the display of the broadcasting system gives a clue to locate the place of the failure. For example, the following three cases can be considered.

(Case 1)

The user can determine whether the correct tuner card 100 has been inserted by checking whether the contents of the display of the system (or corresponding country) coincide with the original system.

(Case 2)

If the system name is displayed on the notebook PC 106, it is confirmed that the two-way communication between the tuner card 100 and the notebook PC 106 is normal. Therefore, when nothing is displayed, it can be determined that the tuner card 100 has not been installed or the tuner card 100 has malfunctioned.

(Case 3)

If no video is displayed even if the system name is shown on the notebook PC 106 and its contents coincide with the tuner card 100, a poor connection of the antenna can be considered.

As described above, when the corresponding system (or corresponding country) is displayed clearly, this helps the user not only recognize the corresponding system but also have various other merits. Therefore, the first embodiment enables the user to readily deal with a different broadcasting system and watch a television broadcast in a different country or region easily.

(Second Embodiment)

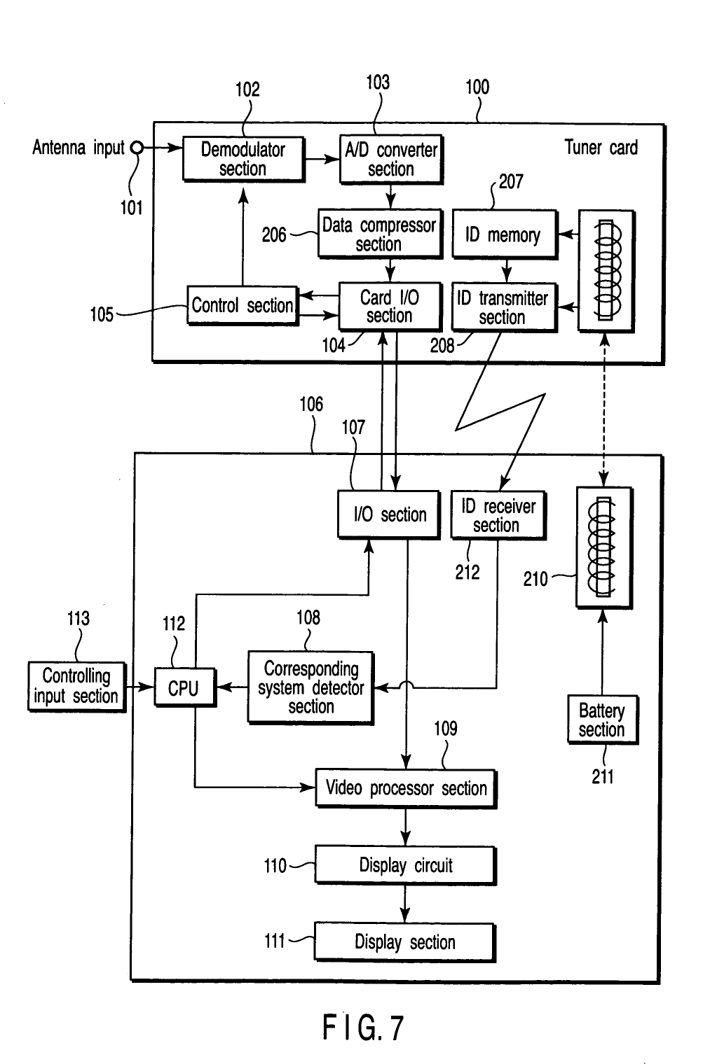

FIG. 7 is a functional block diagram of a second embodiment of the display system of FIG. 1. In FIG. 7, the same parts as those in FIG. 4 are indicated by the same reference numerals. Only what is different from the latter will be explained.

In FIG. 7, the tuner card 100 includes an ID transmitter section 208 and a secondary coil 209. The notebook PC 106 includes an ID receiver section 212 and a primary coil 210. The primary coil 210 is excited by a battery unit 211, thereby producing an induction field. When the tuner card 100 gets closer to the notebook PC 106, the secondary coil 209 is exited by the induction field, with the result that induced electromotive force appears in the secondary coil 209. When the induced electromotive force has exceeded a specific value, then the ID transmitter section 208 is driven. Then, the ID transmitter section 208 reads identification information from the ID memory 207 and radiates electromagnetic waves on which the identification information is superimposed. The electromagnetic waves are received by the ID receiver section 212, which notifies the notebook PC 106 of the identification information. The notified identification information is supplied to the corresponding system detector section 108.

With this configuration, the tuner card 100 need not be installed in the notebook PC 106. For example, just putting both the tuner card 100 and the notebook PC 106 on the same desk enables the notebook PC 106 to recognize the broadcasting system to which the tuner card 100 corresponds. This produces not only the effect of the first embodiment but also the following effect.

All of the tuner cards 100 cannot help having the same shape, regardless of whether the corresponding broadcasting systems differ from one another. Therefore, a card different from the correct one might be installed in the notebook PC 106 because of misjudging or misunderstanding the display. Even if the wrong card has been installed, it takes a specific time to notice that the card is wrong, since the notebook PC 106 detects the installation of the card and then starts the application.

To overcome this problem, the tuner card 100 informs the notebook PC 106 of the corresponding system via a wireless channel before installation in the second embodiment, which prevents the card from being inserted erroneously without the trouble of waiting for the start-up of the system.

The present invention is not limited to the above embodiments.

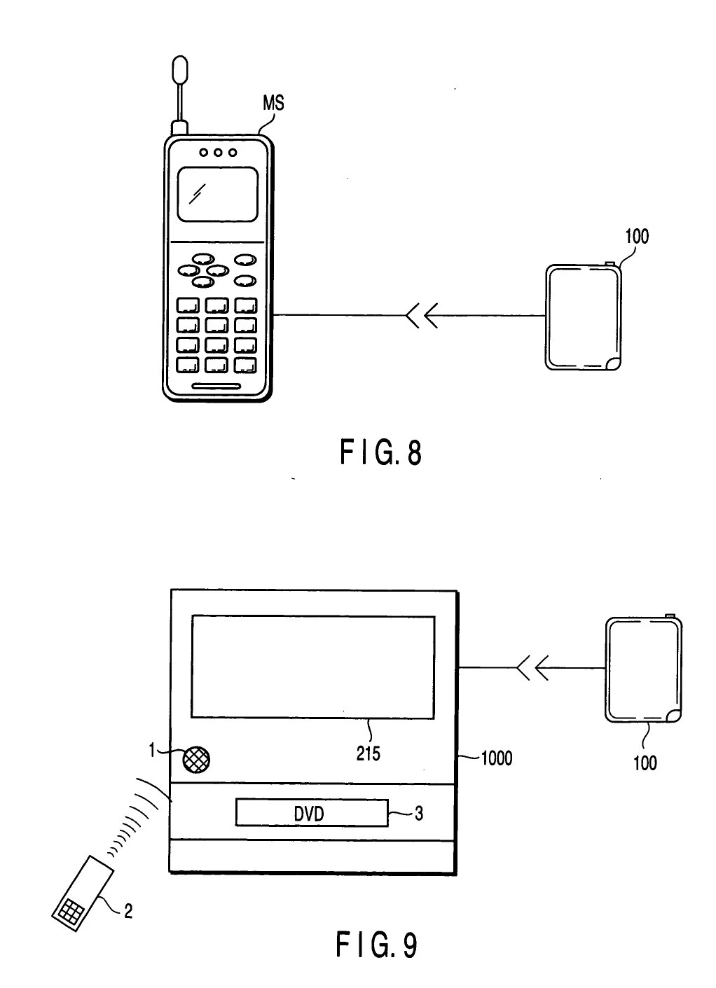

FIG. 8 schematically shows another embodiment of the display system according to the present invention. As shown in FIG. 8, the function of the tuner card 100 in the second embodiment may be provided on a card device to be installed in a mobile telephone MS with a display function. The card device is, for example, an SD I/O card. In this case, MPEG 2 or MPEG 7 may be more suitable as the video data compressing method.

FIG. 9 schematically shows still another embodiment of the display system according to the present invention. As shown in FIG. 9, a dedicated slot may be made in a display apparatus 1000, such as a panel display, thereby enabling the tuner card 100 to be installed. In this case, the video signal output from a Digital Versatile Disk (DVD) unit 3 may be input to the external input terminal of the tuner card 100. The display apparatus 1000 has a light-receiving section 1, which can receive various requests of the user via a remote-control terminal 2. The remote-control terminal 2 corresponds to the controlling input section of FIG. 4.

In the first and second embodiments, the broadcasting system to which the tuner card 100 corresponds has been notified to the notebook PC 106 in the form of identification information. Alternatively, for example, the broadcasting system may be notified in the form of message information. In short, any method of notifying the broadcasting system may be used, as long as the notebook PC 106 can recognize the format.

While in the first and second embodiments, the slot 300 specially shaped to fit the tuner card 100 has been made in the notebook PC 106, a general-purpose card slot may, of course, be used.

Furthermore, the signal output from the demodulator section 102 of FIG. 4 or 7 is not necessarily analog format. For example, when the signal supplied from a terrestrial digital broadcasting system is demodulated, digital video data is obtained. In this case, the demodulated digital data is supplied directly to the data compressor section 206. In the tuner card 100 compatible with such a broadcasting system, the A/D converter section 103 is not needed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A display system comprising:
a broadcast signal processing unit which corresponds to at least one of a plurality of video broadcasting systems differing from each other; and
an information processing terminal in which the broadcast signal processing unit is installed,
the broadcast signal processing unit including
a demodulator which receives a broadcast signal including a video signal and demodulates the video signal,
a data generator which generates digital video data on the basis of the demodulated video signal,
a transmitter which transmits the video data to the information processing terminal, and
a notifying section which informs the information processing terminal of identification information about a video broadcasting system to which the broadcast signal processing unit corresponds, and
the information processing terminal including
a receiver which receives video data transmitted from the transmitter,
a determining section which determines a video broadcasting system to which the broadcast signal processing unit corresponds, from the identification information notified by the notifying section,
a video generator which processes the received video data according to the determined video broadcasting system and generates display video, and
a display section which displays the display video visually.

2. The display system according to claim 1, wherein the notifying section adds the identification information to the video data transmitted by the transmitter and informs the information processing terminal of the resulting identification information.

3. The display system according to claim 1, further comprising a power supply section which supplies power from the information processing terminal to the broadcast signal processing unit, with the broadcast signal processing unit uninstalled in the information processing terminal,
wherein the notifying section includes a wireless transmitter which is driven by the power supplied from the power supply section and radiates electromagnetic waves including the identification information, and
the information processing terminal includes a wireless receiver which receives the electromagnetic waves and informs the determining section of the identification information included in the waves.

4. The display system according to claim 1, wherein the broadcast signal processing unit includes a data compressor which compresses video data generated by the data generator, and
the information processing terminal includes a data expander which expands the compressed video data.

5. The display system according to claim 1, wherein the information processing terminal further includes a channel switching control section which switches the reception channel frequency at the demodulator of the broadcast signal processing unit on the basis of the video broadcasting system determined by the determining section.

6. The display system according to claim 1, wherein the display section displays information for making a visual check of the video broadcasting system determined by the determining section.

7. The display system according to claim 1, wherein the information processing section further includes a slot shaped so as to fit the shape of the broadcast signal processing unit, and
the broadcast signal processing unit is installed in the information processing terminal via the slot.

8. The display system according to claim 7, wherein the information processing unit has a plurality of symbols which are drawn near the slot and correspond to said plurality of video broadcasting systems respectively, and
the broadcast signal processing unit includes an indicator mark pointing at the symbol of the video broadcasting system to which the broadcast signal processing unit corresponds, with the unit inserted in the slot.

9. A broadcast signal processing unit which corresponds to at least one of a plurality of video broadcasting systems differing from each other and is installed in an information processing terminal for use, the broadcast signal processing unit comprising:
a demodulator which receives a broadcast signal including a video signal and demodulates the video signal;
a data generator which generates digital video data on the basis of the demodulated video signal;
a transmitter which transmits the video data to the information processing terminal; and
a notifying section which informs the information processing terminal of identification information about a video broadcasting system to which the broadcast signal processing unit corresponds.

10. The broadcast signal processing unit according to claim 9, wherein the notifying section adds the identification information to the video data transmitted by the transmitter and informs the information processing terminal of the resulting identification information.

11. The broadcast signal processing unit according to claim 9, further comprising a power receiver which receives power from the information processing terminal, with the broadcast signal processing unit uninstalled in the information processing terminal, and
a wireless transmitter which is driven by the power supplied from the power receiver and radiates electromagnetic waves including the identification information.

12. The broadcast signal processing unit according to claim 9, further comprising a data compressor which compresses video data generated by the data generator.

13. The broadcast signal processing unit according to claim 9, including an indicator mark pointing at the symbol of a video broadcasting system to which the broadcast signal processing unit corresponds among a plurality of symbols drawn on the information processing terminal and corresponding to said plurality of video broadcasting systems respectively, with the unit installed in the information processing terminal.

14. A display apparatus in which a broadcast signal processing unit caused to correspond to at least one of a plurality of video broadcasting systems differing from each other is installed, the display apparatus comprising:
a receiver which receives digital video data transmitted from the broadcast signal processing unit;
a determining section which determines a video broadcasting system to which the broadcast signal processing unit corresponds, from identification information about a video broadcasting system notified by the broadcast signal processing unit;
a video generator which processes the received video data according to the determined video broadcasting system and generates display video; and
a display section which displays the display video visually.

15. The display apparatus according to claim 14, further comprising a power supply section which supplies power to the broadcast signal processing unit, with the broadcast signal processing unit uninstalled in the display apparatus, and
a wireless receiver which uses power supplied by the power supply section to receive the electromagnetic waves transmitted from the broadcast signal processing unit and informs the determining section of the identification information included in the electromagnetic waves.

16. The display apparatus according to claim 14, further comprising a data expander which expands the compressed video data transmitted from the broadcast signal processing unit.

17. The display apparatus according to claim 14, further comprising a channel switching control section which switches the reception channel frequency at the broadcast signal processing unit on the basis of the video broadcasting system determined by the determining section.

18. The display apparatus according to claim 14, wherein the display section displays information for making a visual check of the video broadcasting system determined by the determining section.

19. The display apparatus according to claim 14, further comprising a slot which is shaped so as to fit the shape of the broadcast signal processing unit and in which the broadcast signal processing unit is inserted.

20. The display apparatus according to claim 19, further comprising a plurality of symbols which are drawn near the slot and correspond to said plurality of video broadcasting systems respectively.
